(19) United States
(12) Patent Application Publication
(10) Pub. No.: US 2025/0011081 A1
(43) Pub. Date: Jan. 9, 2025

(54) ROBOTIC CONTAINER HANDLER, AN ACCESS AND DISTRIBUTION STATION, A STORAGE AND RETRIEVAL SYSTEM AND A METHOD THEREOF

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 18/705,965

(22) PCT Filed: Oct. 27, 2022
(86) PCT No.: PCT/EP2022/080063

§ 371 Date: Apr. 29, 2024

(30) Foreign Application Priority Data
Oct. 29, 2021 (NO) 20211300

(51) Int. Cl. B65G 1/04; B65G 47/90; G06Q 10/08

(52) U.S. Cl. CPC B65G 1/0464; B65G 47/901; G06Q 10/08

(57) ABSTRACT

A robotic container handler includes a displacement mechanism, a first manipulator, and a second manipulator. The displacement mechanism has a vertical centre plane. The first manipulator includes a first inner end coupled to the displacement mechanism at a first side of the vertical center plane, and a first outer end fixed to a first coupler allowing releasable connection to a container. The second manipulator includes a second inner end coupled to the displacement mechanism at a second side of the vertical center plane opposite of the first side, and a second outer end fixed to a second coupler allowing releasable connection to the container. The displacement mechanism is configured to move the first and second couplers parallel to the vertical center plane.

### FIELD OF THE INVENTION

The present invention relates to a robotic container handler, an access and distribution station comprising the robotic container handler, a storage and retrieval system comprising the access and distribution station and a method thereof.

### BACKGROUND AND PRIOR ART

FIG. 1 discloses a prior art automated storage and retrieval system 1 with a framework structure 100 and FIGS. 2, 3 and 4 disclose three different prior art container handling vehicles 200,300,400 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The automated storage and retrieval system 1 also comprises a rail system 108 arranged across the top of framework structure 100, on which rail system 108 a plurality of container handling vehicles 200,300,400 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 200,300,400 in a first direction X across the top of the frame structure 100, and a second set of parallel rails 111 arranged perpendicular to the first set of rails 110 to guide movement of the container handling vehicles 200,300,400 in a second direction Y which is perpendicular to the first direction X. Containers 106 stored in the columns 105 are accessed by the container handling vehicles 200,300,400 through access openings 112 in the rail system 108. The container handling vehicles 200,300,400 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 200,300,400 comprises a vehicle body 201,301,401 and first and second sets of wheels 202a,202b,302a, 302b,402a, 402b which enable the lateral movement of the container handling vehicles 200,300,400 in the X direction and in the Y direction, respectively. In FIGS. 2, 3 and 4 two wheels in each set are fully visible. The first set of wheels 202a,302a, 402a is arranged to engage with two adjacent rails of the first set 110 of rails, and the second set of wheels 202b,302b,402b is arranged to engage with two adjacent rails of the second set 111 of rails. At least one of the sets of wheels 202a, 202b, 302a, 302b, 402a, 402b can be lifted and lowered, so that the first set of wheels 202a, 302a, 402a and/or the second set of wheels 202b,302b,402b can be engaged with the respective set of rails 110, 111 at any one time.

Each prior art container handling vehicle 200,300,400 also comprises a lifting device 303,403 for vertical transportation of storage containers 106, e.g. raising a storage container 106 from, and lowering a storage container 106 into, a storage column 105. The lifting device 303,403 comprises one or more gripping/engaging devices 404 which are adapted to engage a storage container 106, and which gripping/engaging devices 404 can be lowered from the vehicle 200,300,400 so that the position of the gripping/engaging devices 404 with respect to the vehicle 200,300,400 can be adjusted in a third direction Z which is orthogonal the first direction X and the second direction Y. The gripping device 404 of the container handling vehicle 400 in form of a plurality of claws is shown in FIG. 4. The lifting device of the container handling device 200 is located within the vehicle body 201 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=7 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=5. The container handling vehicles 200,300,400 can be said to travel in layer Z=0, and each storage column 105 can be identified by its X and Y coordinates. Thus, the storage containers shown in FIG. 1 extending above the rail system 108 are also said to be arranged in layer Z=0. The storage volume of the framework structure 100 has often been referred to as a grid, where the possible storage positions within this grid are referred to as storage cells. Each storage column may be identified by a position in an X- and Y-direction, while each storage cell may be identified by a container number in the X-, Y- and Z-direction.

Each prior art container handling vehicle 200,300,400 comprises a storage compartment or space for receiving and stowing a storage container 106 when transporting the storage container 106 across the rail system 108. The storage space may comprise a cavity arranged internally within the vehicle body 201,401 as shown in FIGS. 2 and 4 and as described in e.g. WO2015/193278A1 and WO2019/206487A1, the contents of which are incorporated herein by reference.

FIG. 3 shows an alternative configuration of a container handling vehicle 300 with a cantilever construction. Such a vehicle is described in detail in e.g. NO317366, the contents of which are also incorporated herein by reference.

The cavity container handling vehicle 200 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 400 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110, 111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 200,300,400 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 200,300,400 can drop off storage containers 106 to be transported to an access or a transfer station, and the second port column 120 may be a dedicated pick-up port column where the container handling vehicles 200,300,400 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 200,300,400 is instructed to retrieve the target storage container 106 from its position and transport it to the drop-off port column 119. This operation involves moving the container handling vehicle 200,300,400 to a location above the storage column 105 in which the target storage container 106 is positioned, retrieving the storage container 106 from the storage column 105 using the container handling vehicle's 200,300,400 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 200,300,400 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 200,300,400 is instructed to pick up the storage container 106 from the pick-up port column 120 and transport it to a location above the storage column 105 where it is to be stored. After any storage containers 106 positioned at or above the target position within the stack 107 have been removed, the container handling vehicle 200,300,400 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 200,300,400 so that a desired storage container 106 can be delivered to the desired location at the desired time without the container handling vehicles 200,300,400 colliding with each other, the automated storage and retrieval system 1 comprises a control system 700 which typically is computerized and which typically comprises a database for keeping track of the storage containers 106.

To facilitate the storage and retrieval of inventory and/or other product items 80 stored with the storage containers 106, the product items 80 may be arranged in dedicated delivery containers 20 for handling by systems outside the above described framework structure 100.

An objective of the present invention is therefore to provide a system and a method that allows handling of consolidated delivery containers stored in storage containers.

Another objective of the present invention is to provide a system and a method that allows retrieval and storing of containers in a time efficient and resource saving manner, and with large degree of automatization.

### SUMMARY OF THE INVENTION

The present invention is set forth and characterized in the independent claims, while the dependent claims describe other characteristics of the invention.

In a first aspect, the invention concerns a robotic container handler comprising a displacement mechanism having a vertical centre plane CP_{D}, a first manipulator comprising an inner end coupled to the displacement mechanism at one side of the vertical center plane CP_{D} and an outer end fixed to one or more first couplers allowing releasable connection to one or more containers and a second manipulator comprising an inner end coupled to the displacement mechanism at the opposite side of the vertical center plane CP_{D} and an outer second end fixed to one or more second couplers allowing releasable connection to the one or more containers. The control of the releasable connection to the container(s) by the second coupler(s) may be independent of the control of the releasable connection to the container(s) by the first coupler(s). Further, the displacement mechanism is configured to move the first and second couplers parallel to the vertical center plane CP_{D}, i.e. in vertical and/or horizontal directions.

Alternatively, or in addition, the displacement mechanism and the manipulators may be configured to allow movements perpendicular to the centre plane CP_{D}, for example by use of telescopic manipulator arms and/or multiple joint manipulator arms.

All movements/operations can be controlled by an external control system, for example the control system operating a storage system for which the robotic container handler is interacting with or part of.

The container may be a delivery container (tote) arranged within a storage container (bin). The particular design of the couplers is in this case dependent on the horizontal and vertical size of the delivery container relative to the corresponding horizontal and vertical size of the storage container.

In an exemplary configuration, the displacement mechanism is configured to be mirror symmetric about the vertical centre plane CP_{D}.

In another exemplary configuration, the entire robotic container handler is configured to be mirror symmetric, or near mirror symmetric, about the vertical centre plane CP_{D}.

In yet another exemplary configuration, the outer ends of the manipulators are fixed to a plurality of couplers allowing releasable connection to a corresponding plurality of containers.

In yet another exemplary configuration, the movements of the manipulators are synchronized, for example by use of a single motor constituting part of the displacement mechanism.

In yet another exemplary configuration, the inner ends of one or both of the manipulators are movably coupled to the displacement mechanism such that the inner end(s) may move relative to the displacement mechanism, for example in a linear direction parallel to the floor/base. The latter exemplary configuration has the advantage of increasing positional accuracy.

Alternatively, or in addition, the inner ends are fixed to the displacement mechanism, and the movements of the couplers are achieved by other means such as use of multiple joint manipulators.

In yet another exemplary configuration, the displacement mechanism comprises a stand and a horizontal displacement mechanism comprising a horizontally displaceable part, wherein the horizontal displacement mechanism is configured to move the horizontally displaceable part, and wherein one or both of the inner ends of the manipulators is/are coupled to the horizontally displaceable part. The displacements of the displaceable part may be achieved by one or more dedicated horizontal displacing motors. Moreover, the stand may comprise an upright section and a horizontally extending section extending from the upright section, wherein both manipulators are at least indirectly coupled to the horizontally extending section. Said displacements may be provided through sliding, rolling or both. Horizontal displacements mean hereinafter movements relative to the stand, parallel to the floor/base and along the vertical centre plane CP_{D}.

In yet another exemplary configuration, the displacement mechanism further comprises a vertical displacement mechanism at least indirectly coupled to the horizontally displaceable part. The vertical displacement mechanism comprises a vertically guiding part and a vertical displacement motor configured to move one or both of the manipulators vertically along the vertically guiding part(s). The horizontal and vertical displacing motors may be operated independently.

Alternative embodiments may be envisaged where the vertical displacement mechanism is coupled directly to the stand, i.e. not via the horizontally displaceable part.

In yet another exemplary configuration, the displacement system comprises a stand supportable on a base or floor, a first horizontal displacement mechanism arranged at one side of the vertical center plane CP_{D}, the first horizontal displacement mechanism comprising a first horizontally displaceable part and a first horizontal displacement motor configured to move the first horizontally displaceable part horizontally, and a second horizontal displacement mechanism arranged at the opposite side of the vertical center plane CP_{D}. The second horizontal displacement mechanism comprises a second horizontally displaceable part and a second horizontal displacing motor configured to move the second horizontally displaceable part horizontally. Further, the inner ends are coupled to the horizontally displaceable parts. Preferably the horizontal displaceable mechanisms are configured to be operable independently.

In yet another exemplary configuration, the displacement mechanism further comprises a first vertical displacement mechanism at least indirectly coupled to the first horizontally displaceable part, the first vertical displacement mechanism comprising a first vertically guiding part and a first vertical displacing motor configured to move the first manipulator arm vertically along the first vertically guiding part and a second vertical displacement mechanism at least indirectly coupled to the second horizontally displaceable part, the second vertical displacement mechanism comprising a second vertically guiding part and a second vertical displacing motor configured to move the second manipulator arm vertically along the second vertically guiding part. The horizontal and vertical displacing motors may be operated independently. Further, the displacements of the displacement parts may be provided through sliding, rolling or both.

In yet another exemplary configuration, each coupler comprises a coupler frame and a handle protruding from an upper coupler frame face of the coupler frame, wherein each of the outer ends of the manipulator arms are designed to releasably connect to the handle. The handle may comprise a resilient mechanism allowing damping motion between each outer end and their respective coupler after connection.

In yet another exemplary configuration, each coupler comprises said coupler frame, a gripper protruding from a lower coupler frame face of the coupler frame and an actuator system operatively connected to the gripper to allow the gripper to releasable connect to the container. For example, if the container is arranged within another container, the coupler must be designed to allow gripping of the inner container, thereby setting restrictions to inter alia the size of the coupler frame and/or the positions/lengths of the grippers.

In yet another exemplary configuration, the actuator system of each coupler comprises an actuator motor, an actuator control system configured to control operation of the actuator motor and a linkage interconnecting the actuator motor and the gripper.

In yet another exemplary configuration, each gripper comprises two gripper paddles connected to the coupler frame and arranged at opposite sides of a coupler centre plane oriented perpendicular to the lower coupler frame face. Further, each of the gripper paddles may comprise a gripper protrusion located below the lower coupler frame face for insertion into a corresponding recess or aperture accessible within an inner volume of the container.

In yet another exemplary configuration, the linkage of the actuator of each coupler comprises a first link connected at one end to the actuator motor and the other end to one of the gripper paddles and a second link connected at one end to the actuator motor and the other end to the other of the gripper paddles, wherein the actuator motor is configured to displace the first and second links.

In yet another exemplary configuration, the actuator system of each coupler further comprises a rotary element connecting the first and second links to a rotary shaft of the actuator motor. The actuator motor, the rotary element and the first and second links are configured such that the opposite directed displacements are achieved by rotating the rotary element clockwise or counterclockwise between 0 degrees and 180 degrees, preferably between 80 degrees and 100 degrees, for example 90 degrees.

In yet another exemplary configuration, each coupler further comprises a container sensor configured to sense when a position on the coupler, for example on the lower coupler frame face, is in contact with, and/or in proximity to, an opening frame of the container.

In yet another exemplary configuration, the robotic container handler is a dual station unloader/loader, where the displacement mechanism is designed as a gantry, i.e. a bridge-like overhead structure, having a size straddling a pair of conveyors. The minimum conveyor widths may be defined by the size of the containers to be handled, or, if the container to be handled is arranged within another container, defined by the size of the latter. In this particular configuration, the gantry frame supports the manipulator-coupler assembly on each side, wherein each assembly is configured to transfer containers from one conveyor to the other.

In a second aspect, the invention concerns an access and distribution station configured to handle delivery containers stored within storage containers delivered from within a framework structure of a storage and retrieval system.

The access and distribution station comprises the robotic container handler as described above, a conveyor system comprising an inner conveyor configured to transport containers from a drop-off area in which containers are delivered from the framework structure onto the inner conveyor and into a first container handling area within reach of the first coupler of the robotic picking device. Inner conveyor means herein arranged fully inside, partly inside or adjacent the framework structure.

In an exemplary configuration of the second aspect, the inner conveyor is further configured to transport containers (for example single containers or delivery containers stored within storage containers) through the first container handling area, into a second container handling area within reach of the second coupler of the robotic container handler and further into a pick-up area in which the containers are picked up from the inner conveyor belt and stored within the framework structure, for example by use of vehicles operating on top of the framework structure.

In another exemplary configuration of the second aspect, the conveyor system further comprises an outer conveyor for transport of containers from the first container handling area and to a first external location situated outside, or at least mainly outside, the framework structure.

In yet another exemplary configuration of the second aspect, the conveyor system further comprises an outer conveyor for transport of containers from a second external location outside the framework structure and into a second container handling area within reach of the second coupler of the robotic container handler.

In yet another exemplary configuration of the second aspect, the outer conveyor is further configured to transport the containers from a second external location outside the framework structure, through a second container handling area within reach of the second coupler of the robotic container handler and into the first container handling area.

Outer conveyor means herein outside the inner conveyor relative to the framework structure, such as outside, or mainly outside, the framework structure.

In a third aspect, the invention concerns a storage and retrieval system comprises a framework structure comprising a plurality of vertical upright members defining a plurality of storage columns for storing stacks of storage containers and at least one drop-off port column for transporting a storage container to a drop-off area of an access and distribution station as described above, wherein at least one of the storage containers within the framework structure has a delivery container stored therein. Hence, if the transport is vertical, the drop-off area is situated below the at least one drop-off port column.

The storage and retrieval system further comprises a rail system arranged on the framework structure, one or more remotely operated vehicles comprising drive means configured to travel along the rail system and a storage container lifting device for storing and retrieving storage containers. The rail system comprises perpendicular rails, the intersections of which form a grid made up of grid cells. The rails thus define grid openings for the plurality of storage columns and the storing and retrieving of storage containers takes place through these grid openings.

The displacement mechanism of the robotic container handler may be arranged onto the base/floor supporting the storage and retrieval system or onto an elevated platform. Furthermore, the displacement mechanism may be arranged partly below the rail system or fully below.

In a fourth aspect, the invention concerns a method for handling a delivery container by use of an access and distribution station as described above.

The method comprises the steps of
A. moving the first manipulator of the robot container handler to a position in which the first coupler may connect to a delivery container stored within a storage container,
B. connecting the first coupler to the delivery container and
C. raising the first coupler with the delivery container connected thereto.

The movement of the manipulator in step A may be achieved by operating the horizontal displacing motor or both the horizontal and vertical displacing motors. Moreover, the connection in step B may be achieved by operating the gripper and the actuator system, while raising the coupler in step C may be achieved by operating the vertical displacing motor.

In an exemplary configuration of the fourth aspect, the method further comprises the steps of
transporting (e.g. vertically lowering), prior to step A, the storage container with the delivery container stored therein from the framework structure onto the inner conveyor inside the drop-off area by use of a lifting device and
transporting, prior to step A, the storage container with the delivery container from the drop-off area to the first container handling area by use of the inner conveyor.

The transportation may be performed by a remotely operated vehicle comprising such a lifting device which operates on a rail system as described for the storage and retrieval system in accordance with the third aspect of the invention.

In another exemplary configuration of the fourth aspect, the method further comprises the steps of
transporting the storage container void of the delivery container further through the first container handling area and into a second container handling area within reach of the second coupler of the robotic container handler by operating the inner conveyor,
moving, after step C, the first manipulator to a position in which the first coupler with the delivery container attached thereto is above a part of an outer conveyor arranged inside the first container handling area,
lowering and releasing the delivery container onto the outer conveyor by operating the first manipulator and the actuator system and
transporting the delivery container to a first external location outside the framework structure by operating the outer conveyor.

In another exemplary configuration of the fourth aspect, the method further comprises the steps of
transporting a delivery container into a second container handling area by operating an outer conveyor, typically using the same outer conveyor as for transporting the delivery container to the first external location,
moving the second manipulator of the robot container handler to a position in which the second coupler may connect to the delivery container on the outer conveyor,
connecting the second coupler to the delivery container by operating the actuator system,
raising the delivery container from the outer conveyor by operating the second manipulator,
transporting the storage container void of the delivery container further through the first container handling area and into the second container handling area (i.e. within reach of the second coupler) by the inner conveyor,
moving the second manipulator to a position in which the second coupler with the delivery container is positioned directly above the storage container located inside the second container handling area and
placing and releasing the delivery container into the storage container by operating the second manipulator and the second coupler.

In another exemplary configuration of the fourth aspect, the method further comprises the steps of
transporting the storage container with the delivery container stored therein to a pick-up area by operating the inner conveyor,
picking up the storage container with the delivery container from the inner conveyor within the pick-up area by use of a lifting device and
storing the storage container with the delivery container within the framework structure.

The lifting device may for example be operatively connected to a remotely operated vehicle moving on a rail system as described for the storage and retrieval system in accordance with the third aspect of the invention.

In a fifth aspect, the invention concerns a computer-readable medium having stored thereon a computer program for controlling an access and distribution station according to the second aspect of the invention, the computer program comprising instructions to execute the method steps of the fourth aspect of the invention.

### BRIEF DESCRIPTION OF THE DRAWINGS

The following drawings depict exemplary embodiments of the present invention and are appended to facilitate the understanding of the invention. However, the features disclosed in the drawings are for illustrative purposes only and shall not be interpreted in a limiting sense.

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilever for carrying storage containers underneath.

FIG. 4 is a perspective view of a prior art container handling vehicle having an internally arranged cavity for carrying storage containers therein, wherein the cavity is offset from center relative to a principal direction.

FIG. 5 is a perspective view of part of an automated storage and retrieval system according to the invention, comprising an access and distribution station with a gantry type robotic container handler and conveyors.

FIG. 6 is a perspective view of an access and distribution station of FIG. 5 and a part of the framework into which the robotic container handler and a conveyor may be placed.

FIG. 7 is a perspective view of part of a gantry type robotic container handler of FIGS. 5 and 6 comprising two couplers configured to grip a delivery container stored within a storage container.

FIG. 8 is a perspective view of an operative end of a manipulator having a coupler connected thereon.

FIG. 9 is a side view of a coupler with a delivery container, where FIG. 9A and FIG. 9B shows the coupler in a released and connected position, respectively.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

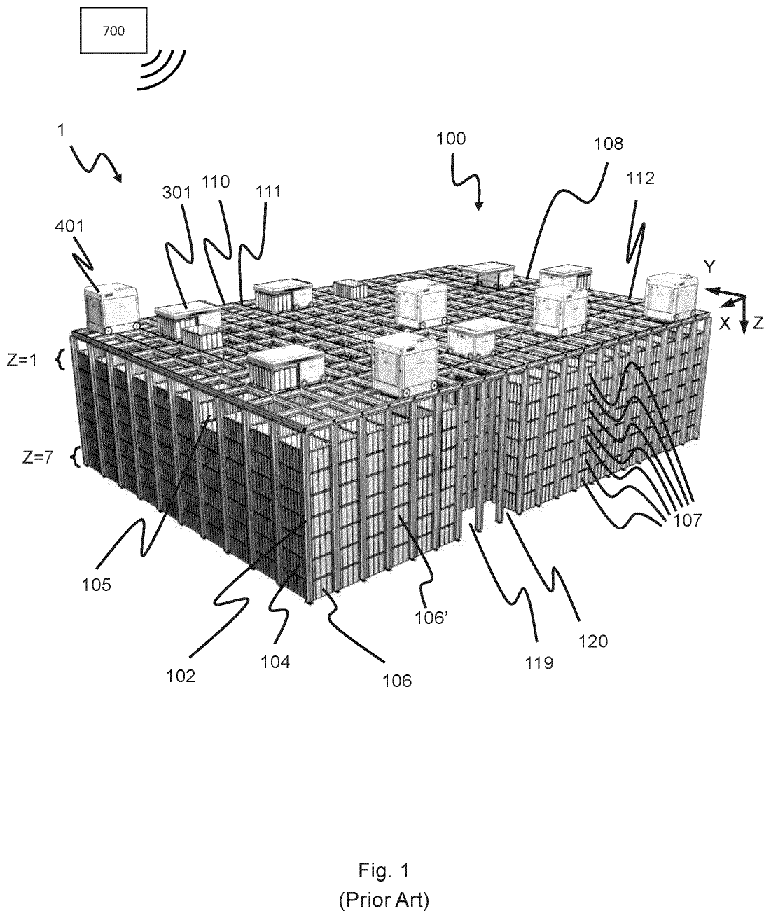

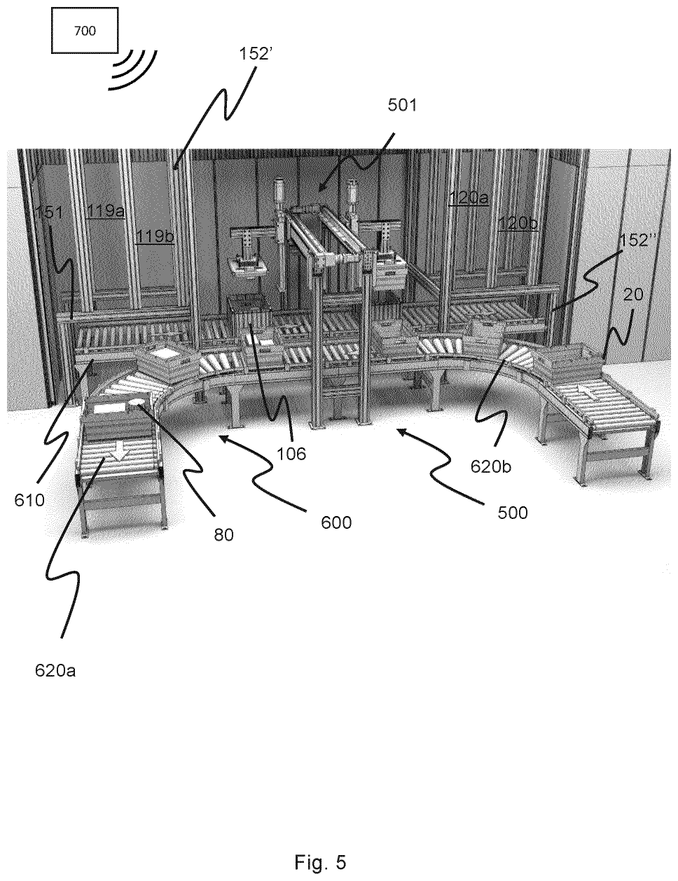

FIG. 5 shows a part of an automated storage and retrieval system 1 in accordance with one embodiment of the invention. The system 1 is equal or similar to the prior art system of FIG. 1, i.e. comprising a framework structure 100 and a plurality of container handling vehicles 200,300,400 moving in X and Y directions on a rail system 108 constituting the topmost part of the framework structure 100. Each container handling vehicle 200,300,400 comprises a lifting device 303,403 configured to lift/lower a container 20,106 from/onto a stack 107 within a storage column 105, and to lower/lift the container 20,106 through a port column 119,120.

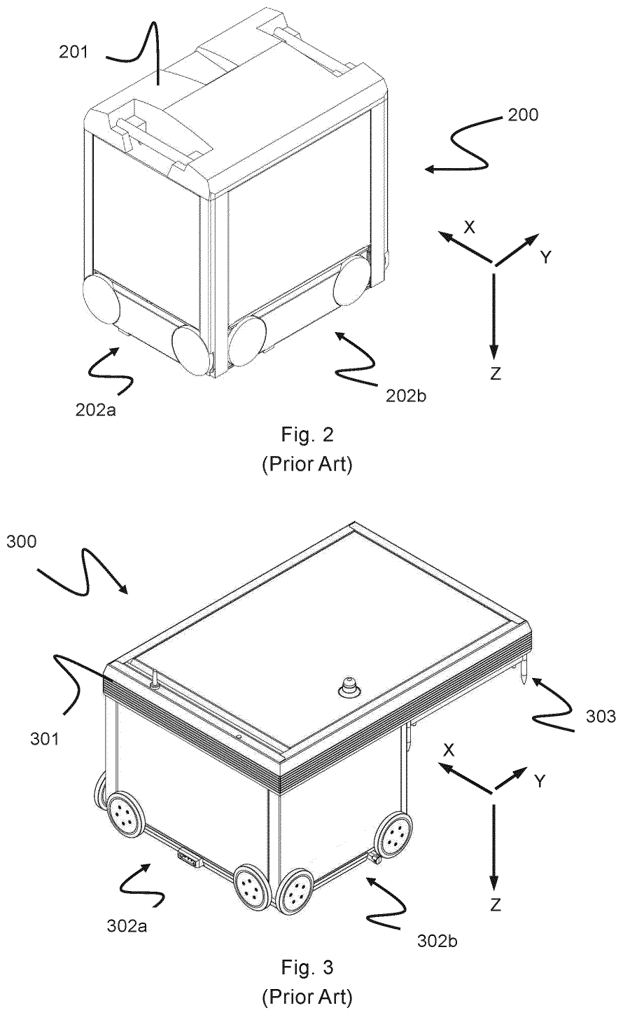

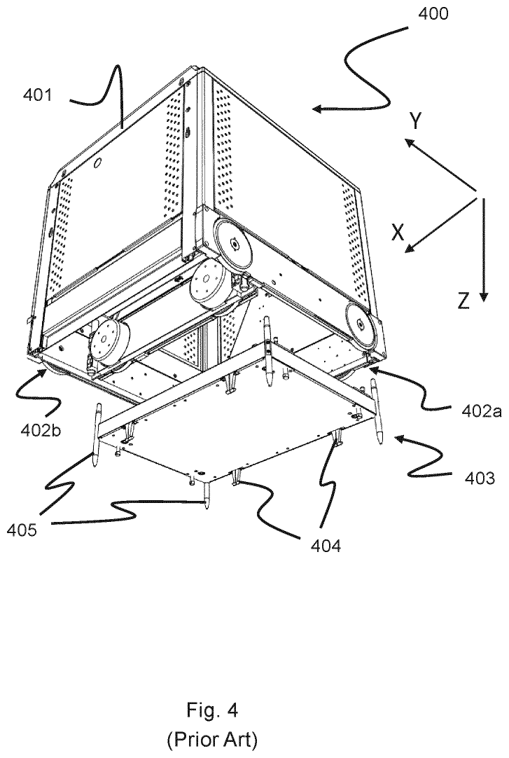

The system 1 is seen to include an access and distribution station 500,600 arranged partly inside the system 1 and which is configured to receive containers 20,106 via vertical port column(s) 119a,b delivered by remotely operated container handling vehicle 200,300,400 operating on the rail system 108 (see FIGS. 1-4). The access and distribution station 500,600 further includes a robotic container handler 500 and a conveyor system 600, wherein the conveyor system 600 is configured to transport the containers 20,106 to/from the robotic container handler 500, as well as to/from an external location outside the horizontal peripheries of the framework structure 100.

In the particular embodiment shown in FIG. 5, the conveyor system 600 comprises two conveyors 610,620;
an inner conveyor 610 arranged directly below a plurality of delivery port columns 119a, 119b and a plurality of receiving port columns 120a, 120b and which pass through a gantry shaped robotic container handler 500, and
an outer conveyor 620 comprising a delivery part 620a arranged to transport containers 20,106 from the robotic container handler 500 to the external location(s) and a receiving part 620b arranged to transport containers 20,106 from the external location(s) to the robotic container handler 500.

As apparent from FIG. 5, the delivery part 620a and the returning part 620b of the outer conveyor 620 are interconnected at the location of the robotic container handler 500.

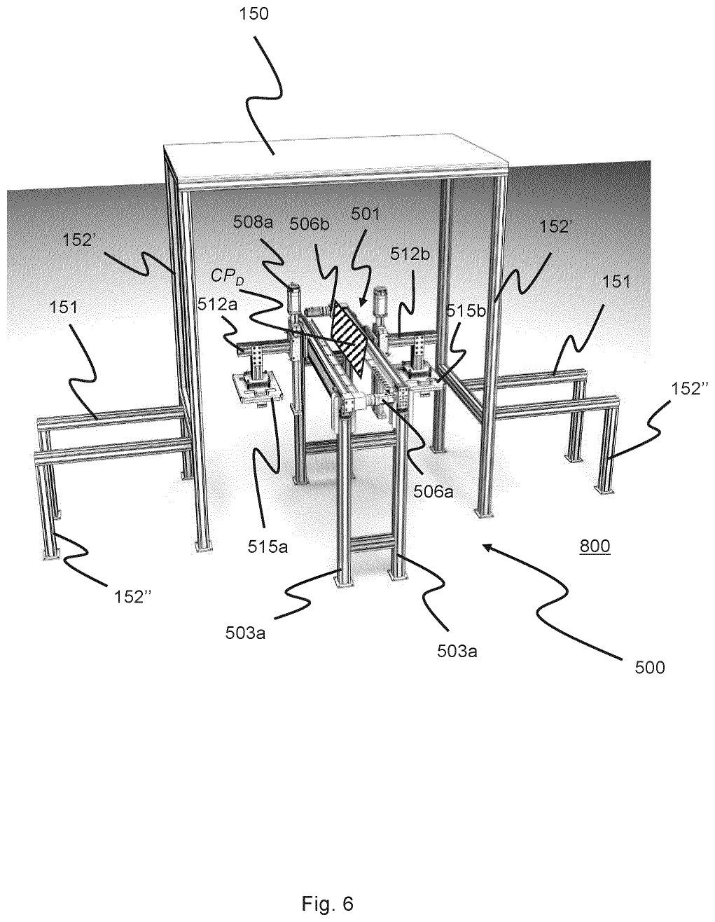

The robotic container handler 500 is placed partly within the framework structure 100 in order for the containers 20,106 transported onto both the inner conveyor and the outer conveyor to pass therethrough. To allow such arrangement, the framework structure 100 may be modified as illustrated in FIGS. 5 and 6. In this particular configuration, the lower end(s) of the delivery port column(s) 119a, 119b and the lower end(s) of the receiving port column(s) 120a, 120b includes horizontal port column beams 151 and vertical port column pillars 152″ to create sufficient space for the inner conveyor 610. Furthermore, a top part 150 and vertical bridging pillars 152′ create sufficient space for the gantry shaped robotic container handler 500. The port column pillars 152″, the bridging pillars 152′ and the robotic container handler 500 are all supported on a floor 800.

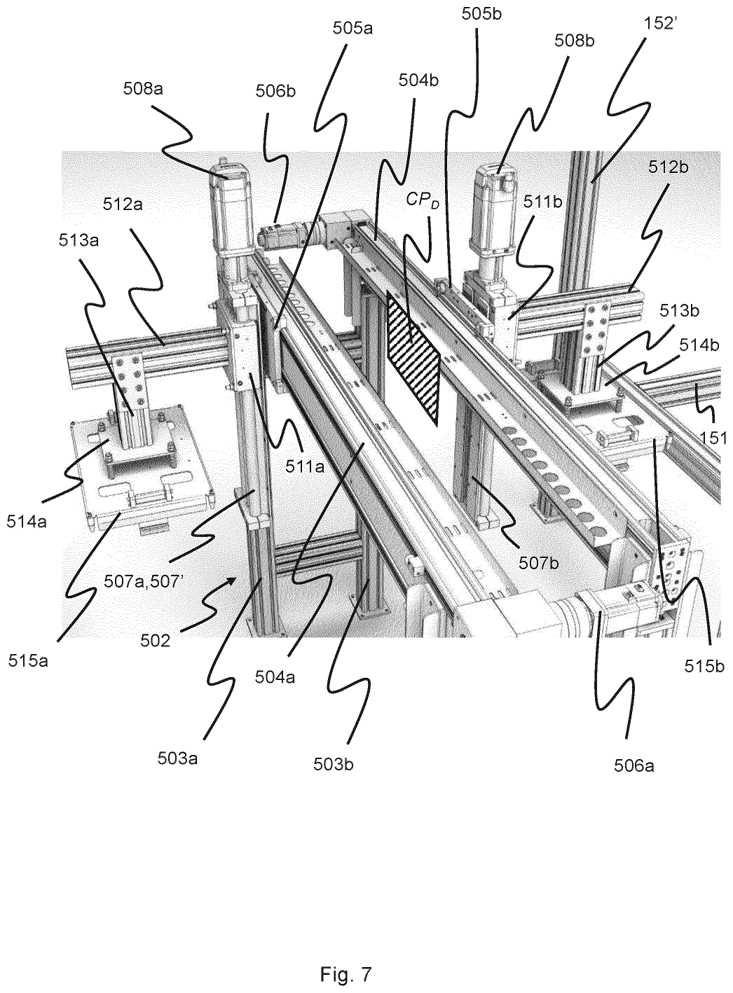

FIG. 7 shows more in detail a part of the robotic container handler 500. The robotic container handler 500 includes a displacement mechanism 501 and two manipulators 511a-514a, 511b-514b arranged on each horizontal sides of the displacement mechanism 501, i.e. towards the locations of the delivery port column(s) 119a, 119b and the receiving port column(s) 120a, 120b, respectively. The coupling between the manipulators 511-514 and the displacement mechanism 501 is such that the manipulators 511-514 may be moved in both vertical and horizontal directs relative to the displacement mechanism 501.

In FIGS. 6 and 7 a vertical center plane CP_{D} of the displacement mechanism 501 is shown, around which the two manipulators 511-514 may be arranged mirror symmetrically.

With particular reference to FIG. 7, the displacement mechanism 501 may comprise a stand 502 having vertical pillars 503a,503b supported on the floor 800 and horizontal beams 504a,504b arranged on the delivery and receiving sides of the vertical center plane CP_{D}, thereby creating a bridge shape under which the conveyor system 600 may pass through.

The displacement mechanism 501 further includes two horizontally displaceable parts 505a,505b mounted onto each horizontal beams 504a,504b such that controlled horizontal displacements are possible via dedicated motors 506a, 506b, for example DC motors.

To also allow vertical displacement, a vertically guiding part 507a,507b with one or more vertical guiding rods 507′ at desired lengths may be displaceably coupled to each horizontally displaceable parts 505a,505b. The inner manipulator end section 511a,511b of each manipulators 511a-514a,511b-514b may thus be displaceably coupled to guiding rods of the guiding part 507a,507b. The controlled vertical displacements of the manipulators 511a-514a,511b-514b may be achieved by dedicated motors 508a,508b connected to the guiding parts 507a,507b, for example DC motors. Furthermore, stable and precise vertical guidance may be achieved by vertical channels/tracks 511′ on the inner manipulator end sections 511a, 511b, wherein the channels/tracks 511′ are arranged to slide along the guiding rods 507′.

In addition to the inner manipulator end sections 511a,511b, each manipulator 511a-514a, 514b-514b may comprise a horizontal manipulator arm 512a,512b fixed at one end to the end sections 511a, 511b, a vertical manipulator arm 513a, 513b fixed onto the horizontal manipulator arm 512a,512b and a coupler end section 514a, 514b fixed to the lower end of the vertical manipulator arm 513a, 513b. In the embodiments shown in the figures, the coupler end section 514a, 514b is in form of a horizontal plate attached to an upper face 520″ of the coupler 515 via resilient fixing means.

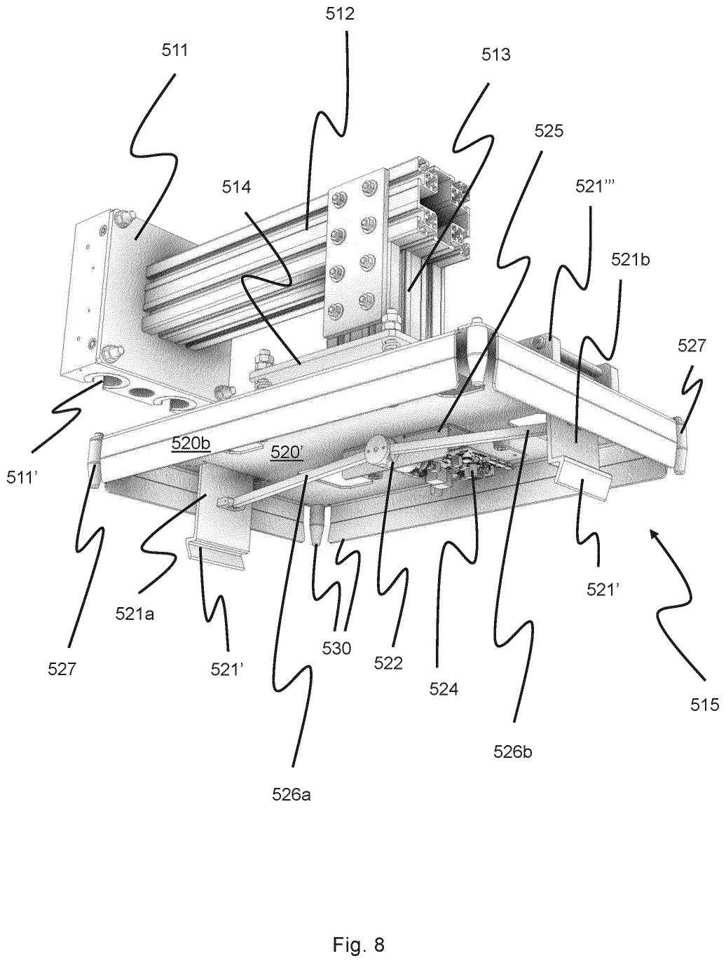

In FIGS. 7 and 8, the vertical manipulator arm 513a, 513b is stationary fixed to the horizontal manipulator arm 512a,512b. Other configurations may however be envisaged, such as a displaceable coupling in which the vertical manipulator arm 513a, 513b may move along the horizontal manipulator arm 512a, 512b.

A coupler 515a, 515b is fixed to each coupler end section to allow releasable coupling to a container 20,106.

With reference to FIG. 5, the system 1 comprises in the illustrated embodiment two types of containers, a delivery container/tote 20 and a storage container/bin 106. The relative sizes and designs of the totes and bins 20,106 are such that at least one of the totes 20 may be placed inside the bin 106.

Each tote 20 may contain one or more product items 80 that may be handled by e.g. human and/or robotic operators (not shown). Hereinafter, a tote 20 arranged within a bin 106 is referred to as a tote-in-bin 20,106.

The coupler 515a, 515b shown in FIGS. 5-9 are particularly configured to allow releasable coupling with a tote 20 in a tote-in-bin 20,106 arrangement. However, alternative configurations may be envisaged such as couplers adapted to allow releasable coupling with only the bin 106 in the tote-in-bin 20,106 arrangement and/or with both the bin 106 and the tote 20.

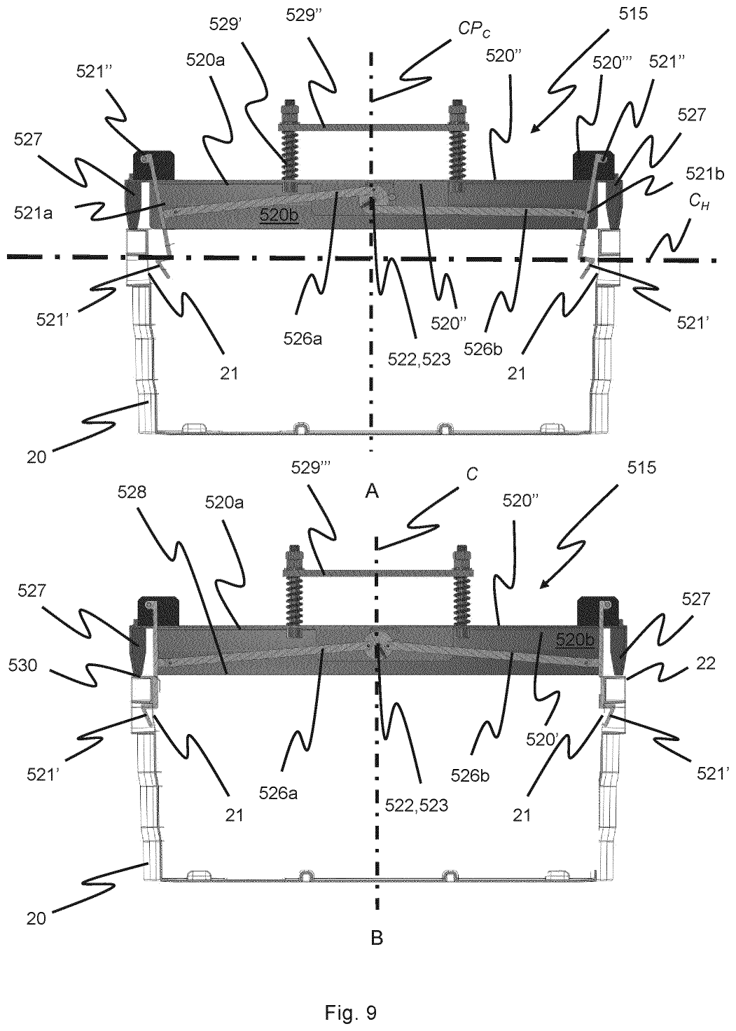

FIGS. 8 and 9 show an embodiment where a tote contacting face 530 of a coupler 515 is abutting an opening frame/rim 22 of a tote 20. The exemplary coupler 515 includes a coupler frame 520 comprising a rectangular, horizontal coupler plate 520a having an lower coupler frame face 520′ and an upper coupler frame face 520″, tote abutment sensors 527 extending downwards from the corners of the coupler plate 520a and angled coupler plates 520b arranged between the coupler plate's corners and extending downwards from rims/boundaries of the coupler plate 520a.

The purpose of the abutment sensors 527 is to register abutment with the rim 22 of the tote 20 and may e.g. be mechanical sensors such as pressure activated sensors or electronical proximity sensors. In the former case, the extent of the tote abutment sensors 527 should be equal or longer than the extent of the angled coupler plates 520b, thereby ensuring that the tote abutment sensors 527 exerts pressure on the rim 22 at contact and/or detect proximity.

In the particular case where the tote 20 should be picked up from, or inserted into, a bin 106 being higher and slightly wider than the tote 20, at least part of the angled coupler plates 520b may advantageously be slanted inwards in order to avoid undesired abutment between the plates' 520b rim and an upper rim of the bin 106 defining its opening.

The coupler 515 further comprises two container gripper paddles 521 (a first paddle 521a and a second paddle 521b), hereinafter called tote paddles, where each tote paddle 521a,521b has a gripper protrusion 521′ at the lower end such as a ledge, rib or fold, and where the upper end 521″ of each paddle 521 is attached pivotally and/or resiliently to the coupler plate 520a and/or to respective upper blocks 520″ fixed on opposite horizontal sides of the coupler plate's 520a upper face 520″, i.a. on opposite sides of a vertical centre plane (Pc shown in FIG. 9.

If such upper blocks 520′″ are present, the coupler plate 520a should be designed with through-going openings having a position and size to allow sufficient horizontal movements of the tote paddles 521. Moreover, the tote paddles 521 are arranged such that the protrusions 521′ are located at vertical height(s) of recesses/apertures 21 within inner walls of the tote 20 when the coupler frame 520 is abutting the opening frame/upper rim 22 of the tote 20.

An actuator system 522-526, which also forms part of the coupler 515, is arranged at least partly within the volume set by the lower face 520″ of the horizontal coupler plate 520a and the angled coupler plates 520b. The actuator system 522-526 is configured such that it may displace the first and second tote paddles 521a, 521b in opposite directions by remote operation. The actuator system 522-526 may alternatively be protruding partly or fully from said volume.

In the particular embodiment shown in FIGS. 8 and 9, the actuator system 522-526 includes a motor 522, a control system 524 allowing control of the operation of the motor 522 and signal communication with a control system 700, a rotary disc 523 connected to the motor 522 and two links/displacement arms 526a, 526b connecting the rotary disc 523 to each of the tote paddles 521a, 521b.

The motor 522, the rotary disc 523 and the control system 524 are fixed to the lower face 520′ of the coupler plate 520a by a motor support 525 in the form of an angle bracket. The motor 522 may for example be a DC motor.

The two links 526a, 526b are in FIGS. 8 and 9 configured and sized in the following way:

A first end of the first link 526a and a first end of the second link 526b are pivotably connected to the rotary disc 523 at opposite sides of the disc's 523 horizontal rotational axis, while a second end of the first link 526a and a second end of the second link 526b are pivotably connected to the first tote paddle 521a and the second tote paddle 521b, respectively.

The positions, angles and lengths of the tote paddles 521 are adjusted such that the protrusions 521′ are aligned at the same vertical level as the gripping structure (recesses/apertures) 21 of the tote 20 when in the position shown in FIG. 9.

Furthermore, the actuator system 522-526 is configured such that the horizontal deflections of the tote paddles 521 are sufficient to switch the tote paddles 521 between a lock position where the protrusions 521′ are inside the respective recesses/apertures 21 and a release position where the protrusions 521′ are outside the respective recesses/apertures 21. In this way, a controllable gripping/releasing operation of the tote 20 is achieved.

As best seen in FIG. 9A and FIG. 9B, the particular configuration with opposite positioned first ends on the rotary disc 523 result in an equal displacement of the links 526a,526b, and a corresponding equal pivoting of the tote gripper paddles 521a,521b, when the motor 522 rotates the rotary disc 523 an angle necessary for achieving the desired gripping of the tote 20, preferably within a range of 70-100°, for example 90°.

As mentioned above, the couplers 515a,515b are attached to the coupler end sections 514a, 514b of the respective manipulators 511a-514a, 511b-514b. As seen in FIGS. 8 and 9, one or both of the coupler end sections 514a, 514b may comprise one or more resilient suspensions attached at one end to the coupler frame 520 and the other end to a horizontal plate. Due to the suspensions, the abutment of the coupler 515 with the upper rim 22 of the tote 20 does not create excessive force onto the manipulator 511-514 and/or the tote 20.

By use of the above described coupler 515, the robotic container handler 500 described in connection with FIG. 5-7 is capable of picking up/insert totes 20 inside bins 106 from both sides of the vertical centre plane CP_{D}. When the robotic container handler 500 and the conveyor system 600 form part of an access and distribution station placed within the particular configuration of the framework structure 100 as described above, an automated process is achieved that allows retrieval and storing of tote-in-bins in a highly efficient and resource saving manner. The automated process performed by the access and distribution station 500,600 may be controlled by a dedicated control system and/or the same control system 700 governing the operation of the container handling vehicles 200,300,400 on top of the rail system 108.

In general, the robotic container handler 500 is arranged such that each coupler 515a, 515b may be maneuvered to a position centered above the container(s) 20,106/tote-in-bins when transported by the inner conveyor 610 to a specific position or specific positional range from the vertical centre plane CP_{D} and be maneuvered to a position above the outer conveyor 620.

One particular example of operation using a robotic container handler 500 and a conveyor system 600 in a storage and retrieval system 1 as described above, and shown in FIGS. 1-9, is a method for handling totes-in-bins 20,106, where the bins 106 shall stay within or near the peripheries of the framework structure 100 and the totes 20 contains items/products 80 to be delivered to end-customers.

Such an operation may contain some or all of the following steps:
1. One or more vehicle 200,300,400 are instructed to move to positions on the rail system 108 where their respective lifting devices are aligned directly above storage columns 105 into which a bin 106 containing a target tote 20 is arranged on top of a stack 107.
2. The vehicle(s) 200,300,400 lower(s) the lifting device(s) to the tote-in-bin arrangement 20,106 until the gripper elements 404 may perform a releasable grip with corresponding gripping structures of the bin (typically at the bin's rim).
3. The vehicle(s) 200,300,400 lift(s) the lifting device(s) 303,403 with the bin-in-tote arrangement such that the bottom of the bin 106 is positioned a distance above the rail system 108.
4. The vehicle(s) 200,300,350 move(s) to a position in which the lifting device 303,403 with the tote-in-bin arrangement is positioned directly above respective dedicated drop-off port column(s) 119 (see FIGS. 1 and 5) and the tote-in-bin arrangement(s) is/are lowered through the port column(s) 119 and onto the inner conveyor 610 of the access and distribution station 500,600 arranged at the port columns' lower end(s).
5. The inner conveyor 610 transports the tote-in-bin arrangement(s) towards the robotic container handler 500.
6. When a tote-in-bin arrangement is within reach of the coupler 515a at the handler's 500 delivery side, the control system 700 sends instructions to the displacement mechanism 501 to maneuver the corresponding manipulator 511a-514a with the coupler 515a such that the protrusions 521′ of the tote paddles 521 are in alignment with the respective gripping structures 12 of the tote 20.
7. The control system 524 instructs the motor 522 to rotate the rotary disc 523, and thereby to move the links 526a, 526b outwards in opposite directions such that the protrusions 521′ couple with the gripping structure 12 (see FIG. 9b). The commands may be sent directly from the control system 700 to receivers on the coupler's control system 524. Receivers may alternatively, or in addition, form an integral part of the motor 522.
8. The manipulator 511a-514a lifts the coupler 515a with the attached tote 20 by operating the motor 508a coupled to the vertically guiding part 507a such that the bottom of the tote 20 is situated above the uppermost position of the bin 106.
9. The manipulator 511a-514a moves the coupler 515a with the tote 20 to a position above the delivery part 620a of the outer conveyor 620 by operating the motor 506a coupled to the horizontally displaceable part 505a.
10. The tote 20 is lowered onto the outer conveyor 620 by operating the motor 508a of step 8 and the tote paddles 521 are released from the respective gripping structures 12 of the tote 20.
11. The outer conveyor 620 transports the tote 20 containing product items 80 to an external location. The inner conveyor 610 transports another tote-in-bin arrangement within reach of the coupler 515a at the delivery side.
12. The outer conveyor 620 transports a tote 20 towards the robotic container handler 500.
13. When the tote 20 is within reach of the coupler 515b at the handler's 500 receiving side, the control system 700 sends instructions to the displacement mechanism 501 to maneuver the corresponding manipulator 511b-514b with the coupler 515b such that the protrusions 521′ of the tote paddles 521 are in alignment with the respective gripping structure 12 of the tote 20.
14. The manipulator 511b-514b lifts the coupler 515b with the attached tote 20 by operating the motor 508b coupled to the vertically guiding part 507b such that the bottom of the tote 20 is situated above the uppermost position of a bin 106 at the inner conveyor 610 ready to receive the tote 20.
15. The manipulator 511b-514b moves the coupler 515b with the tote 20 horizontally to a position above the bin 106 on the inner conveyor 610 by operating the motor 506b coupled to the horizontally displaceable part 505b.
16. The tote 20 is lowered into the bin 106 by operating the motor 508b of step 14 and the tote paddles 521 are released from the respective gripping structures 12 of the tote 20.
17. Via a pick-up port column 120, the tote-in-bin arrangement created in step 16 is raised to a position above the rail system 108 by use of a vehicle 200,300,400 and subsequently placed in a storage column 105 by performing any of points 1-4 in opposite directions.

In a preferred embodiment, the framework structure 100 contains a plurality of drop-off port columns 119 and/or a plurality of pick-up port columns 120 in order to further improve the time efficiency of the access and distribution station 500,600.

In the preceding description, various aspects of the robotic container handler for handling containers such as tote-in-bins, an access and distribution station and an automated storage and retrieval system using such a robotic container handler and associated methods have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Automated storage and retrieval system
20 Delivery container/tote
20′ Incoming delivery container/incoming tote
21 Gripping structure/formation within delivery container, recess/aperture
22 Opening frame of a delivery container/rim/upper edge
80 Product item
100 Framework structure
102 Upright members of framework structure
105 Storage column
106 Storage container/bin
106′ Particular position of storage container
107 Stack
108 Rail system
110 Parallel rails in first direction (X)
112 Access opening
119 Delivery port column
120 Receiving port column
150 Top part
151 Horizontal port column beams
152′ Bridging pillars
152″ Port column pillars
200 Prior art central cavity container handling vehicle
201 Vehicle body of the container handling vehicle 200
202a Drive means/wheel arrangement/first set of wheels in first direction (X)
202b Drive means/wheel arrangement/second set of wheels in second direction (Y)
300 Prior art container handling vehicle
301 Vehicle body of the container handling vehicle 300
302a Drive means/first set of wheels in first direction (X)
302b Drive means/second set of wheels in second direction (Y)
303 Storage container lifting device
400 Prior art container handling vehicle
401 Vehicle body of the container handling vehicle 401
402a Drive means/first set of wheels in first direction (X)
402b Drive means/second set of wheels in second direction (Y)
403 Lifting device
404 Gripper elements/claws for storage container 106
405 Guiding pins for storage container 106
500 Robotic container handler
501 Displacement mechanism
502 Stand
503a Vertical pillars of stand 502 (delivery side)
503b Vertical pillars of stand 502 (receiving side)
504a Horizontal beams of stand 502 (delivery side)
504b Horizontal beams of stand 502 (receiving side)
505a Horizontally displaceable part (delivery side)
505b Horizontally displaceable part (receiving side)
506a Motor for horizontally displaceable part (delivery side)
506b Motor for horizontally displaceable part (receiving side)
507a Vertical guiding part (delivery side)
507b Vertical guiding part (receiving side)
507′ Vertical guiding rods
508a Motor for vertically guiding part (delivery side)
508b Motor for vertically guiding part (receiving side)
511a Inner manipulator end section (delivery side)
511b Inner manipulator end section (receiving side)
511′ Vertical channels/tracks
512a Horizontal manipulator arm (delivery side)
512b Horizontal manipulator arm (receiving side)
513a Vertical manipulator arm (delivery side)
513b Vertical manipulator arm (receiving side)
514a Coupler end section (delivery side)
514b Coupler end section (receiving side)
515a Coupler (delivery side)
515b Coupler (receiving side)
520 Coupler frame
520a Horizontal coupler plate
520b Angled coupler plate
520′ Lower coupler frame face/lower face
520″ Upper coupler frame face/upper face
520′″ Upper end gripper block/upper block
521 Container gripper paddle/Tote gripper paddle
521a First container gripper paddle/first paddle
521b Second container gripper paddle/second paddle
521′ Gripper protrusion
521″ Upper end of gripper paddle/upper end of tote paddle
522 Motor (for displacing gripper paddles 521)
523 Rotary disc (rotationally connected to motor 522)
524 Control system
525 Motor support/angle bracket
526 Links/displacement arms
526a First link
526b Second link
527 Delivery container sensor/tote abutment sensor
528 Container contacting face/tote contacting face
529 Handle/connection device
529′ Resilient mechanism/vertical suspension
529″ Handle plate
530 Tote contacting face
600 Conveyor system
610 Inner conveyor
620 Outer conveyor
620a Outer conveyor, delivery part
620b Outer conveyor, receiving part
700 Control system
800 Platform/floor
X First direction
Y Second direction
Z Third direction
CP_{D} Vertical centre plane of robotic container handler 500
CP_{C} Vertical centre plane of coupler

1. A robotic container handler comprising:
a displacement mechanism having a vertical centre plane,
a first manipulator comprising:
a first inner end coupled to the displacement mechanism at a first side of the vertical center plane, and
a first outer end fixed to a first coupler allowing releasable connection to a container, and
a second manipulator comprising:
a second inner end coupled to the displacement mechanism at a second side of the vertical center plane opposite of the first side, and
a second outer end fixed to a second coupler allowing releasable connection to the container,
wherein the displacement mechanism is configured to move the first and second couplers parallel to the vertical center plane.

2. The robotic container handler in accordance with claim 1, wherein at least one of the first inner end and the second inner end is movably coupled to the displacement mechanism.

3. The robotic container handler in accordance with claim 1, wherein the displacement mechanism comprises:
a stand, and
a horizontal displacement mechanism comprising a horizontally displaceable part, and wherein the horizontal displacement mechanism is configured to move the horizontally displaceable part,
wherein at least one of the first inner first end and the second inner end of the manipulators is/are coupled to the horizontally displaceable part.

4. The robotic container handler in accordance with claim 3, wherein the displacement mechanism further comprises:
a vertical displacement mechanism coupled to the horizontally displaceable part, the vertical displacement mechanism comprising:
a vertically guiding part, and
a vertical displacement motor configured to move at least one of the first manipulator and the second manipulator vertically along the vertically guiding part.

5. The robotic container handler in accordance with claim 1, wherein each coupler comprises:
a coupler frame,
a gripper protruding from a lower coupler frame face of the coupler frame, and
an actuator system operatively connected to the gripper to allow the gripper to releasable connect to the container.

6. The robotic container handler in accordance with claim 5, wherein the actuator system of each coupler comprises:
an actuator motor,
an actuator control system configured to control operation of the actuator motor, and
a linkage interconnecting the actuator motor and the gripper.

7. The robotic container handler in accordance with claim 5, wherein each gripper comprises two gripper paddles connected to the coupler frame and arranged at opposite sides of a coupler centre plane oriented perpendicular to the lower coupler frame face, and
wherein each of the gripper paddles comprises a gripper protrusion located below the lower coupler frame face for insertion into a corresponding recess or aperture accessible within an inner volume of the container.

8. The robotic container handler in accordance with claim 7, wherein the linkage of the actuator of each coupler comprises:
a first link connected at one end to the actuator motor and the other end to one of the gripper paddles and
a second link connected at one end to the actuator motor and the other end to the other of the gripper paddles,
wherein the actuator motor is configured to displace the first and second links.

9. An access and distribution station configured to handle delivery containers stored within storage containers delivered from within a framework structure of a storage and retrieval system, the access and distribution station comprising:
a robotic container handler comprising:
a displacement mechanism having a vertical centre plane,
a first manipulator comprising:
a first inner end coupled to the displacement mechanism at a first side of the vertical center plane, and
a first outer end fixed to a first coupler allowing releasable connection to a container, and
a second manipulator comprising:
a second inner end coupled to the displacement mechanism at a second side of the vertical center plane opposite of the first side, and
a second outer end fixed to a second coupler allowing releasable connection to the container,
wherein the displacement mechanism is configured to move the first and second couplers parallel to the vertical center plane, and
a conveyor system comprising an inner conveyor configured to transport containers from a drop-off area in which containers are delivered from the framework structure onto the inner conveyor and into a first container handling area within reach of the first coupler of the robotic container handler.

10. The access and distribution station in accordance with claim 9, wherein the inner conveyor is further configured to transport containers;
through the first container handling area,
into a second container handling area within reach of the second coupler of the robotic container handler, and further
into a pick-up area in which the containers are picked up from the inner conveyor belt and stored within the framework structure.

11. The access and distribution station in accordance with claim 9, wherein the conveyor system further comprises an outer conveyor for transport of containers:
from the first container handling area, and
to a first external location situated outside the framework structure.

12. The access and distribution station in accordance with claim 11, wherein the outer conveyor is further configured to transport the containers;
from a second external location outside the framework structure,
through a second container handling area within reach of the second coupler of the robotic container handler, and
into the first container handling area.

13. A storage and retrieval system comprises:
a framework structure comprising a plurality of vertical upright members defining a plurality of storage columns for storing stacks of storage containers and at least one drop-off port column for transporting a storage container to a drop-off area of an access and distribution station, wherein at least one of the storage containers within the framework structure has a delivery container stored therein,
a rail system arranged on the framework structure the rail system comprising perpendicular rails, the intersections of which form a grid made up of grid cells, the rails defining grid openings for a plurality of storage columns, and
a remotely operated vehicle comprising drive means configured to travel along the rail system and a storage container lifting device for storing and retrieving storage containers through the grid openings.

14. A method for handling a delivery container by use of an access and distribution station configured to handle delivery containers stored within storage containers delivered from within a framework structure of a storage and retrieval system, the access and distribution station comprising:
a robotic container handler comprising:
a displacement mechanism having a vertical centre plane,
a first manipulator comprising:
a first inner end coupled to the displacement mechanism at a first side of the vertical center plane, and
a first outer end fixed to a first coupler allowing releasable connection to a container, and
a second manipulator comprising:
a second inner end coupled to the displacement mechanism at a second side of the vertical center plane opposite of the first side, and
a second outer end fixed to a second coupler allowing releasable connection to the container,
wherein the displacement mechanism is configured to move the first and second couplers parallel to the vertical center plane, and
a conveyor system comprising an inner conveyor configured to transport containers from a drop-off area in which containers are delivered from the framework structure onto the inner conveyor and into a first container handling area within reach of the first coupler of the robotic container handler, wherein the method comprises:
A. moving the first manipulator of the robotic container handler to a position in which the first coupler may connect to a delivery container stored within a storage container,
B. connecting the first coupler to the delivery container, and
C. raising the first coupler with the delivery container connected thereto.

15. The method in accordance with claim 14, wherein the method further comprises:
transporting, prior to A, the storage container with the delivery container stored therein from the framework structure onto the inner conveyor inside the drop-off area by use of a lifting device, and
transporting, prior to A, the storage container with the delivery container from the drop-off area to the first container handling area by use of the inner conveyor.

16. The method in accordance with claim 15, wherein the method further comprises:
transporting the storage container further through the first container handling area and into a second container handling area within reach of the second coupler of the robotic container handler,
moving, after C, the first manipulator to a position in which the first coupler with the delivery container attached thereto is above a part of an outer conveyor arranged inside the first container handling area,
lowering and releasing the delivery container onto the outer conveyor, and
transporting the delivery container to a first external location outside the framework structure by use of the outer conveyor.

17. The method in accordance with claim 15, wherein the method further comprises:
transporting a delivery container into a second container handling area by use of an outer conveyor,
moving the second manipulator of the robot container handler to a position in which the second coupler may connect to the delivery container on the outer conveyor,
connecting the second coupler to the delivery container,
raising the delivery container from the outer conveyor,
transporting the storage container further through the first container handling area and into the second container handling area,
moving the second manipulator to a position in which the second coupler with the delivery container is positioned directly above the storage container inside the second container handling area, and
placing and releasing the delivery container into the storage container.

18. A computer-readable medium having stored thereon a computer program for controlling an access and distribution station, the computer program comprising instructions causing a processor to execute the method according to claim 14.
